(19) United States
(12) Patent Application Publication
(10) Pub. No.: US 2006/0106668 A1
(43) Pub. Date: May 18, 2006

(54) Method for creating an on-line leads marketplace

(76) Inventors: John Sung Kim, (US); Maad Abu-Ghazalah, (US)

Correspondence Address: Maad Abu-Ghazalah, P.O. Box 1219, Pacifica, CA, 94044, US

(21) Appl. No.: 11/273,287

(22) Filed: Nov. 14, 2005

Related U.S. Application Data
(60) Provisional application No. 60/627,557, filed on Nov. 12, 2004.

(51) Int. Cl. G06F 17/30

(52) U.S. Cl. 705/10

(57) ABSTRACT

A method is presented for obtaining and selling contact information electronically. The method comprises obtaining contact information from visitors to web sites sponsored in pay-per-click links and automatically categorizing the contact information based on the keywords used to get the pay-per-click link. The system further comprises including additional leads for sale after evaluating the leads and assigning them a rating.

We claim priority to: Provisional Application No. 60/627,557 filed on Nov. 12, 2004.

### BACKGROUND OF THE INVENTION

1. Field of the Invention

The present invention relates to an improved data processing system, and, in particular, to a business practice.

2. Description of Related Art

On-line purchases through the internet have gained a great deal of popularity and account for billions of dollars in sales. In addition, on-line marketplaces have been created, such as the one created by eBay®, whereby buyers bid against each other in on-line auctions.

There also exists a high demand for sales leads. That is because a certain percentage of leads can typically be converted into sales, so the more leads a salesperson has the more sales that person can make. In addition, the more specific the leads are to the salesperson's industry, the more valuable those leads are to that person.

Although there is a large demand for leads, no viable on-line marketplace exists for leads for two reasons. First, there is no consistent source of leads that can be sold. There are a very limited number of companies that have leads to sell, so the volume of leads is not sufficient to support an on-line marketplace. Although most companies have their own leads database, it is proprietary and they have a counter-incentive to make their leads available to their competitors.

Second, buyers of leads have little way of validating the quality of leads offered on the internet. Because of the volume of leads involved, a potential buyer would have a limited capability of determining if the contact information is accurate or how likely it will actually lead to a sale. For example, validating the leads through call centers could be prohibitively costly. In addition, leads databases are typically not related to a particular market, so the value of the leads may not be very high. For example, leads obtained from a web site about motorcycles may not be of much value to a company selling infant clothing. For this reason, buyers would be hesitant to make any significant purchases from an on-line marketplace without some way of determining the value of those leads.

### SUMMARY OF THE INVENTION

A method is presented for obtaining and selling contact information electronically. The method comprises obtaining contact information from visitors to web sites sponsored in pay-per-click links and automatically categorizing the contact information based on the keywords used to get the pay-per-click link. The system further comprises including additional leads for sale after evaluating the leads and assigning them a rating.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1 is a flow chart depicting the process through which a lead seller can obtain and sell automatically categorized leads.

FIG. 2 is a flow chart depicting the process through which contact information is obtained from pay-per-click sponsored links.

FIG. 3 is a flow chart depicting the process through which leads are assigned a rating prior to being offered for sale on an on-line marketplace.

### DETAILED DESCRIPTION OF THE INVENTION

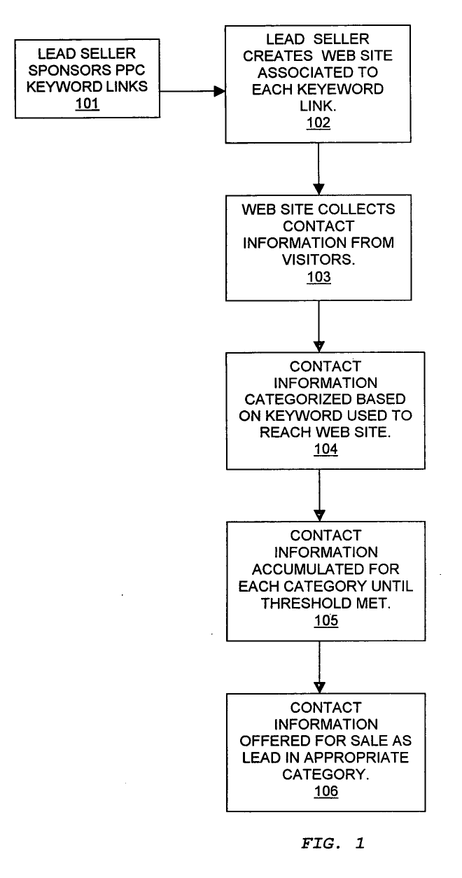

With reference now to FIG. 1, a flow chart depicts the process of obtaining and selling automatically categorized leads. The process begins with the Lead Seller sponsoring pay-per-click (PPC) keyword links (step 101). A PPC keyword link is paid advertising whereby the owner of a search engine (such as Google™ or Yahoo!®) displays a link to a sponsor's web site in exchange for a fee each time the user of the search engine clicks the link.

The Lead Seller then creates a web site associated with each sponsored keyword (step 102). For example, if the Lead Seller sponsors the keyword “doctor”, the Lead Seller would create a web site that would be of interest to a person who enters “doctor” as a keyword in a search engine.

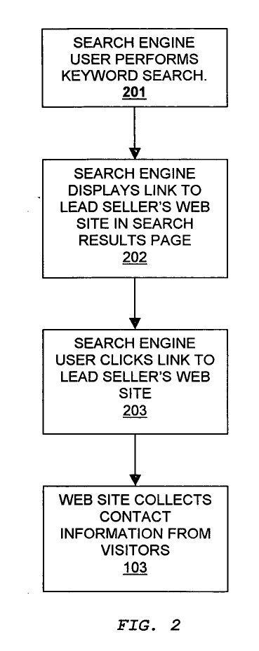

With reference now to FIG. 2. a flow chart depicts the process through which said web sites can be used to obtain contact information from search engine users. The search engine user types in keywords to be processed by the search engine (step 201). When one or more of the keywords entered by a search engine user matches a keyword sponsored by the lead seller, a link to the lead sellers web site associated with the keyword is displayed in the search results page (step 202). When the search engine user clicks on the link to the lead seller's web site (step 203), the search engine user goes to the lead seller's web site, i.e. said user becomes a visitor to said web site. Said web site then collects contact information from said visitor (step 103 in FIG. 1 and FIG. 2). An example of how the web site can obtain contact information from a visitor is by creating a doctor referral service web site associated with the keyword “doctor”. The web site asks the visitor to provide contact information if the visitor wishes to be contacted by a doctor.

With reference again to FIG. 1, the contact information is then stored by the web site and categorized according to the keyword used to reach it (step 104). For example, if the Lead Seller sponsors three keywords, “motorcycle”, “medicine” and “doctor”, the Lead Seller could create two web sites, one to be displayed as a link on a search engine result page for the keyword “motorcycle” and one to be displayed as a link on a search engine result page for the keywords “medicine” and “doctor”. Contact information obtained from visitors to the web site associated with “motorcycle” would be categorized under “motorcycle” and any other category related to motorcycles, whereas contact information obtained from visitors to the web site associated with “medicine” and “doctor” would be categorized under “medicine”, “doctor” and any other category related to doctors and medicine.

In one embodiment, the contact information is accumulated by the web site until a threshold amount of contact information has been stored (step 105). This is not a necessary step to the invention, but makes the process more efficient by grouping leads together and processing them as a group rather than one-by-one. In addition, it is more likely that contact information can be sold as a group rather than on a one-by-one basis. For example, the web site may accumulate contact information until a threshold of 1000 contacts have been stored prior to passing the contact information to the next step in this invention.

The contact information is then offered for sale as a lead under the appropriate category (step 106). As described in step 104, the category is determined by the keyword used to reach the web site from which the contact information is collected. Therefore, the contact information is a relevant lead in that category. Said lead would be of value to a person who is interested in selling products or services in said category. In the examples provided above, the contact information obtained from a visitor to a web site that is a doctor referral service would be of great utility to a doctor who would be a likely buyer of said contact information.

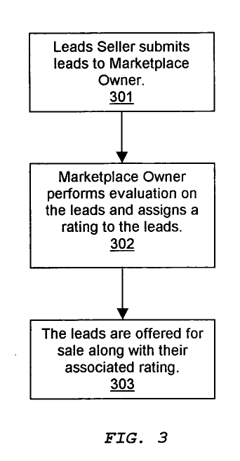

With reference now to FIG. 3, a flow chart depicts the process of creating an on-line leads marketplace by assigning a rating to the leads offered for sale. First, a Lead Seller submits leads to an on-line leads Marketplace Owner to be offered for sale (step 301).

Said Marketplace Owner then evaluates said leads in order to assign them a rating (step 302). There are several methods the Marketplace Owner can use to evaluate said leads. Some examples of evaluation methods include factoring the quality of the source of the leads (i.e. how the leads were obtained); determining the history of the lead seller if he or she has sold leads before; making an extrapolation by sampling a portion of the leads; cross-checking the leads with existing leads databases to insure that the leads were not simply taken from another database in order to be re-sold and that the leads do not match known inaccurate lead information; determining data completeness since the more information the contact provides, the more likely it is to be accurate; ensuring the leads do not appear on “Do Not Call” lists; and factoring the age of the leads since the more recently leads were obtained the more likely they are to be accurate. When the Marketplace Owner completes the evaluation process a rating is assigned to the leads based on the results of the evaluation.

The leads are then offered for sale in an on-line marketplace (step 303). The rating of the leads assigned in step 302 is visible on the marketplace so that all potential buyers can compare the relative value of leads prior to purchasing them.

In one embodiment of the on-line leads marketplace, the Marketplace Owner facilitates the buying and selling of leads by automatically charging the buyer when a purchase is made and automatically depositing the purchase amount into the lead seller's account.

In another embodiment of the on-line leads marketplace, the market place owner follows up with the buyer of leads to determine the quality of the leads. The evaluation of the buyer is stored as part of the lead seller's history and is used as part of the leads evaluation process (step 302) of leads offered by said seller at a future date.

In another embodiment of the on-line leads marketplace, the leads offered for sale include contact information obtained through registration for Podcasts. Podcasts are either video or audio transmissions to Apple iPods® or other electronic receiving device. These transmissions contain specific information requested by the receiving party. In order to receive said transmissions, the receiving party must usually fill out a registration which can include contact information. Said contact information can be automatically submitted to an on-line leads marketplace to be offered for sale. These leads are of particular value since they can be categorized according to the type of information of the Podcast. For example, a lead obtained from a Podcast about the housing market would be of particular value to a mortgage lender.

In another embodiment of the on-line leads marketplace, the leads offered for sale include contact information obtained from RSS streams. RSS is a format for distributing changes to web sites. Subscribers to RSS streams automatically receive content changes to web sites they subscribe to. The RSS streams can be used to obtain contact information from subscribers. For example, the RSS stream may broadcast a message such as “Enter you contact information to receive a free stereo.” The contact information is then stored and automatically submitted to an on-line leads marketplace for sale.

In another embodiment of this invention, potential leads buyers and sellers are provided the ability to fill out a profile for the types of leads they are interested in. The marketplace owner then automatically notifies said buyers and sellers whenever leads matching their profile are posted for sale and of the status of the sale. An example of the utility of this embodiment is that a buyer will not need to constantly monitor the marketplace to see when leads of interest to him or her are offered for sale. This embodiment is also useful to sellers as they will be notified of the sales price of leads meeting the profile. If the seller wishes to post a batch of leads in the future matching that profile, the seller would have a better idea of the approximate price he or she can expect to be able to sell those leads.

In another embodiment of an on-line leads marketplace, contact information obtained through pay-per-click sponsored links, as described earlier and in FIG. 1 and FIG. 2, is automatically submitted to an on-line leads marketplace to be offered for sale as leads. After the contact information is obtained and categorized by the web site (FIG. 1 step 104), they are automatically submitted to the on-line leads marketplace for sale.

1. A method for obtaining and selling automatically categorized leads comprising the following steps:
A. Sponsoring pay-per-click (PPC) keyword links.
B. Creating a web site associated with each said keyword link.
C. Obtaining contact information from visitors to each said web site.
D. Categorizing said contact information based on the keyword associated to each said web site.
E. Offering said contact information for sale as leads categorized according to step D.

2. The method for obtaining and selling automatically categorized leads in claim 1 further comprising the step of accumulating the contact information until a threshold number has been obtained prior to offering the contact information for sale as categorized leads.

3. A method for creating an on-line leads marketplace comprising evaluating leads and assigning them a rating prior to offering them for sale.

4. A method for creating an on-line leads marketplace in claim 3 whereby an accounting system is created to automatically charge buyers of said leads and automatically paying the sellers of said leads.

5. A method for creating an on-line leads marketplace in claim 3 whereby feedback is obtained on the quality of said leads by the buyer of the leads from a seller in order to help determine the rating of the leads offered by said seller at a future time.

6. A method for creating an on-line leads marketplace in claim 3 whereby the source of said leads includes contact information obtained through registration for Podcasts.

7. A method for creating an on-line leads marketplace in claim 3 whereby the source of said leads includes contact information obtained from subscribers to RSS feeds streams.

8. A method for creating an on-line leads marketplace in claim 3 whereby potential buyers and sellers create a profile and are automatically notified whenever leads are offered for sale that meet their profile.

9. A method for creating an on-line leads marketplace in claim 3 wherein the contact information obtained in claim 1 is automatically submitted to the on-line leads marketplace to be offered for sale.
